(19) United States
(12) Patent Application Publication
(10) Pub. No.: US 2017/0109839 A1
(43) Pub. Date: Apr. 20, 2017

(54) Artist Discovery System

(71) Applicant: SUM Entertainment, Inc., Atlanta, GA (US)

(72) Inventor: Ron Berryman, Atlanta, GA (US)

(21) Appl. No.: 15/294,660

(22) Filed: Oct. 14, 2016

Related U.S. Application Data
(60) Provisional application No. 62/241,596, filed on Oct. 14, 2015.

(51) Int. Cl. G06Q 50/00; G06Q 30/02; G06F 17/30

(52) U.S. Cl. CPC G06Q 50/01; G06F 17/3053; G06Q 30/0201; H04L 67/306

(57) ABSTRACT

Described herein is a system for scoring performers, such as artists, to more efficiently identify talent. For competitions involving a creative element, the system can determine scores for performers based on their content, personality profile, connections to other users, and the interactions of other users with them and their content. The system can score users based on analysis of social, audience, engagement, and reach characteristics.

### CROSS REFERENCE TO RELATED APPLICATION

This application claims priority to provisional patent application No. 62/241,596 (“Systems for Multisource Collaborative Scoring”), filed Oct. 14, 2015, which is incorporated by reference in its entirety.

### BACKGROUND

The Internet has made it possible for musicians and other artists to gain worldwide exposure with just a few clicks. However, it has also become harder to separate the artists with potential from those without it. The same technology that makes publication easy for artists also makes it more difficult to identify the new artists that are likely to succeed. A need exists for quickly comparing artists based on characteristics that correlate to successful label and publishing outcomes.

Currently, gauging the future success of creative endeavors is done based on gut feelings, instincts, and serendipity. This can mean that data about success or failure only enters the discussion at a point where the success or failure is already imminent. At early stages in the process, with great numbers of possible successes (many of which will end up being failures), the volume and noisiness of potentially useful data can be challenging. The patterns that develop across multiple sources—such as websites and social networks with hundreds, thousands or millions of users in play—may simultaneously be valuable indicia of success and yet impracticable to incorporate in a meaningful way in the traditional approach.

Competitions like AMERICAN IDOL allow companies to identify future stars. This is done based in-part on public input. However, this input is generally limited to votes by text message or email. This process does not necessarily predict which artists ultimately have the greatest potential for success, or even accurately reflect existing sentiment toward the artists.

Therefore, a need exists for artist discovery systems.

### SUMMARY

Embodiments of a collaborative scoring system for identifying artists with success potential are described herein. An example system can score collaborative challenges based at least in part on social (e.g. how many people reach a user via social networks), audience (e.g., the number of social networks linked to the user), engagement (e.g., shares and reshares of the user's content), and reach (e.g., the number of connections the user has across their social accounts). The system can determine an engagement score based on assigning points to, for example: profile creation, followers, following, messaging followers, uploading assets, sharing content, making a group, contributing to a group with an asset, invites to projects, making a contest, adding an asset to a contest, completing a contest, advancing in the contest, and based on registration of invited users.

By rating the user (e.g., author or artist) against other users, competitions can be determined based on more than simply amassing votes. Instead, the system can leverage online social analysis to determine a winner.

### BRIEF DESCRIPTION OF THE DRAWINGS

FIG. 1 depicts an overview of an exemplary multisource collaborative scoring system.

FIG. 2 depicts an exemplary computer system capable of carrying out the processes of a multisource collaborative scoring system.

FIG. 3A depicts an exemplary method for using a multisource collaborative scoring system.

FIG. 3B depicts an exemplary method for using a multisource collaborative scoring system.

FIG. 3C depicts an exemplary method for using a multisource collaborative scoring system.

FIG. 4 is an exemplary illustration of a console.

FIG. 5 is an exemplary illustration of a console.

FIG. 6A is an exemplary illustration of a console.

FIG. 6B is an exemplary illustration of a console.

FIG. 7 is an exemplary method executed by a system.

### DETAILED DESCRIPTION

Reference will now be made in detail to exemplary embodiments consistent with the invention, examples of which are illustrated in the accompanying drawings. Wherever possible, the same reference numbers will be used throughout the drawings to refer to the same or like parts.

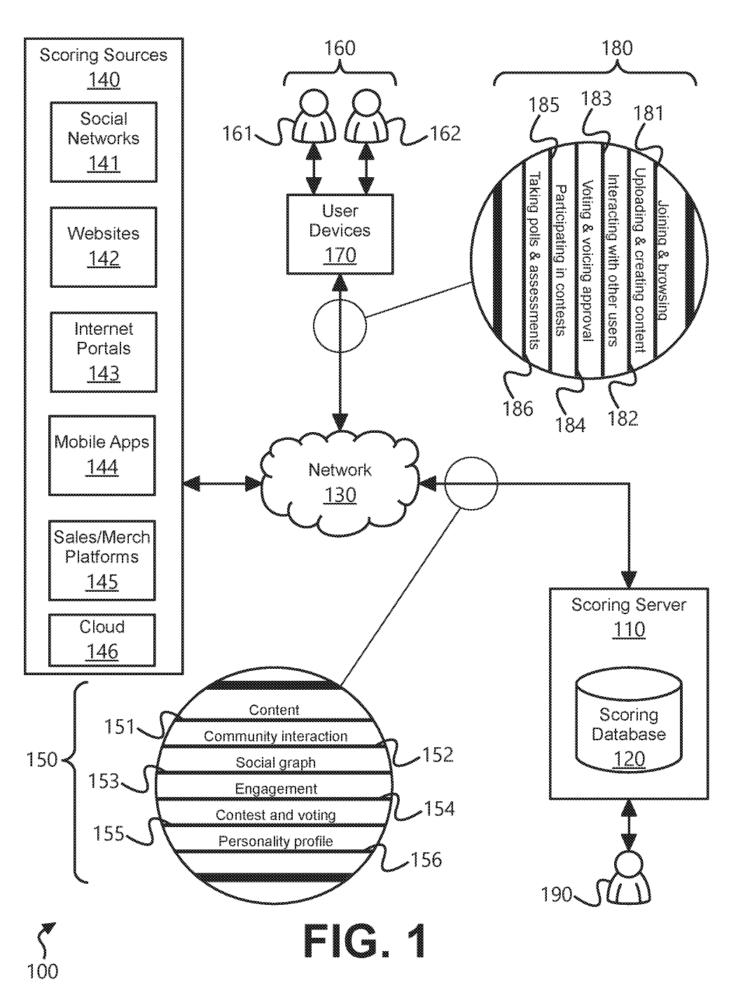

Referring now to FIG. 1, there is shown an exemplary overview of an example system 100. The system 100 can be used to identify promising performers, such as artists. The system 100 can include a collaboration platform where performers are ranked against each other based on live performance feedback, raw social media numbers (e.g., follows), and fan engagement on social platforms (e.g., shares and reshares).

In various embodiments, the system 100 can assist an administrator in determining favorable characteristics about one or more users by determining a multisource collaborative score (“MCS”) for those users. Such characteristics can relate to, for example, the marketability of a musical artist's music and persona, the future performance of a designer's upcoming seasonal fashion line, the breadth of appeal of a comedian, the differentiability of a potential marketing campaign, and other factors. The system 100 can determine MCS values based on various data and indicia of user and content interactions received from scoring sources 140 (such as social networks 141 and websites 142) in an example. The scoring sources can 140 can be cloud-based 146 in an example.

The administrator can belong to an artist and repertoire (“A&R”) firm in one example. The system can help the administrator recognize talented performers more efficiently.

In an embodiment, system 100 can include a scoring server 110. Scoring server 110 can include a database 120 that stores user, activity, and scoring data. In one example, database 120 can include multiple databases. The scoring server 110 may be connected to user devices 170 and/or other scoring services 140 via a communication network 130 such as the internet, a cellular or wireless network, a local area network (“LAN”), an enterprise wide area network (“WAN”), a workstation peer-to-peer network, a direct link network, or any other suitable communication channel.

The scoring server 110 can algorithmically score collaborative challenges by calculating and weighting scores associated with social (e.g. how many people reach a user via social networks), audience (e.g., the number of social networks linked to the user), engagement (e.g., shares and reshares of the user's content), and reach (e.g., the number of connections the user has across their social accounts). The data required for determining these scores can be retrieved from the scoring sources 140.

Additionally, the functions of one or more scoring sources 140, scoring servers 110, and/or scoring databases 120 may be aggregated or contained in one or more non-transitory computer-readable mediums. For example, a social network 141 could include one or more databases that store user interaction 180 data and scoring data 150, and act as both a scoring source 140 and a scoring server 110. Such a configuration could be physically housed in a single location, or across multiple datacenters, or in a distributed computing network. In another example, system 100 can include a scoring server 110 whose hardware components were physically or even geographically separate from the hardware components of a dedicated scoring database 120.

System 100 may have one or more system operators 190 that may have the ability to set up, operate, direct, administer, connect, alter the parameters of, or otherwise utilize a scoring server 110, scoring database 120, or scoring source 140. A system operator 190 can be, e.g. a website administrator, developer, or programmer for a scoring source 140 or scoring server 110 that utilizes system 100 to determine MCS values. A system operator 190 can also be a person or entity that operates, sponsors, establishes, moderates, or controls a contest, content portal, social media website, internet community, talent search. and incorporates or interfaces with system 100 to determine MCS values.

In an embodiment, a general population of users 160 who interact over a network 130 with one or more scoring sources 140 and/or scoring servers 110 can include scored users 161 and non-scored users 162. Scored users 161 can be a subset of the general population of users 160 for which MCS values are determined, while system 100 may not determine MCS values for other, non-scored users 162. Scored users 161 can be that subset of users for which scoring source 140 or scoring server 110 operators wish to ascertain favorable qualities (e.g. artistry, marketability, mass appeal.).

In an example, scored users 161 can be users who create and/or upload content (e.g. graphic art, comedy skits, musical compositions, fashion designs, written material.). In an example, scored users 161 can be those users who enter themselves or their content into the scoring system via sign-up or other actions, such as competitions, contests, challenges, scored by a scoring server 110 or otherwise by system 100.

Non-scored users 162 can be a subset of the general population of users 160, such as fans, viewers, browsing individuals, social network participants., for whom system 100 does not determine MCS values. In some examples, users may not have scoring and non-scoring subsets. For example, all users may be scored users 161, or the individuals being scored are not themselves “users” or connected to scoring sources 140 by a network 130. In another example, the “user” scored by system 100 can be an individual piece or body of content (e.g. a commercial jingle, an album, a series of paintings, a set of political platform points), rather than a person, band, or entity. In yet another example, users' status as a scoring 161 or non-scoring 162 user can change over time or at the direction of a system operator 190. Scoring server 110 can have point values and/or proportional weights assigned to various types of data stored in the scoring database 120 and can determine user MCS values by aggregating the points/weights assigned to respective data types in an example.

A user device 170 can be any computing device, such as a cell phone, laptop, tablet, personal computer, or workstation. Users can interact with one or more scoring sources 140, the content therein, and/or other users thereof, over a communication network 130 via user devices 170. For example, users can visit, be members of (e.g. sign up with, or have accounts, profiles or pages on), or otherwise interface with scoring sources 140.

Scoring sources 140 can include social networking sites 141, websites 142, internet communities and fora, internet portals 143 for content (e.g. video or audio portals, user-generated content sites), web applications, mobile applications 144, sales and merchandising platforms 145 (e.g. traditional and online retail, app stores, ticket sales, radio spins, licensing, advertising, and streaming platforms), and others. Descriptions herein pertaining to a “website,” “database,” “portal,” “app,” “server,” or similar also apply to other like components, such as a traditional HTTP/S website; a web-based or network application; a web or network server; a cloud service; a mobile app; a locally-hosted application or data source; a hardware- or software-mediated data store, database, or subcomponent thereof (such as a database table); a peer-to-peer protocol; or, an RSS-style data feed.

In an embodiment, users can interact 180 with a scoring source 140 or scoring server 110 in various ways. The following are non-limiting examples of ways users may interact with scoring sources 140. A basic way a user may interact is joining and browsing 181, including signing up, setting up a profile, and viewing links, profiles, pages, posts, videos, and other content. A user may create or upload content 182 (e.g., audio, video, graphical, textual, material) to, e.g., a social media profile, video hosting portal, artist promotional platform, or band contest website.

A user may interact with other users 183 by connecting (e.g. “friending,” “following,” “approving”), messaging, or forming/joining groups with them. Another way a user may interact with other users is by voicing approval 184, as by e.g. “liking,” “upvoting,” commenting on, or reposting another user's uploads, posts, submissions. A user may participate in contests 185, as an entrant, spectator, or judge. A user may also partake in assessments 186, such as quizzes, personality questionnaires, polls.

In an embodiment, system 100 can include scoring data 150 regarding various user interactions 180 with scoring sources 140. Such data may be received by scoring server 110, stored in scoring database 120, and used in the determination of MCS values in an example. Such data may reflect user interactions 180 consistent with those described in the preceding paragraph, or may reflect more, fewer, or different interactions, activities, correlations, or data points.

In an example, system 100 can track data across a plurality of scoring sources 140—e.g. band websites; multiple social media networks and accounts; “battle of the bands”-style and other competition websites; email networks; audio/video content portals; fan interaction and other mobile apps; content purchasing, downloading, and streaming sources; search engine results and other aggregators of preference and interest data; and other sources. System 100 can track data about various actions and interactions of both scored 161 and non-scored 162 users in an example.

System 100 may track scoring data 150 components such as content data 151, community interaction data 152, social graph data 153, user engagement data 154, contest and voting data 155, and personality profile data 156. The following are non-limiting examples of scoring data 150 the system 100 may include in the determination of MCS values.

System 100 may track content data 151 regarding the frequency, volume and/or nature of a scored user's 161 created/uploaded content. This can include, for example, the completeness of profiles, age of accounts, number and constancy of posts and content contributions, sharing or reposting content, and other measures of user content generation.

System 100 may track community interaction data 152 regarding the frequency, volume, and/or nature of a scored user's 161 activity and interaction with other users. This can include, for example, messaging, texting, emailing textual or other content, commenting, answering questions, and joining groups.

System 100 may track social graph data 153 regarding the breadth, depth, and/or nature of a scored user's 161 links to other users. This can include, for example, the number of the scored user's 161 connections (e.g. friends, followers, and subscribers). This can also include the number of social and other networks on which the scored user's 161 connections are made, referrals and sign-ups of users, and the qualities of connected users. The latter can include, e.g., how many friends the scored user's 161 friends have, the amount of influence or “reach” of followers, how much content the scored user's 161 viewers view, and the purchasing and consumption habits of users that have interacted with the scored user's 161 content.

System 100 may track user engagement data 154 regarding the engagement of other users with a scored user's 161 content. This can include, for example, the number of views, likes, votes, shares, reposts, a scored user's 161 profile or content received. This can also include the length of time users interact with a scored user's 161 profile or content, or the nature of the interactions. The latter can include, e.g., watching all or only part of a video, whether a user reached the content by searching for the scored user 161 in a search engine, and inclusion of the name or content of the scored user 161 in a user's own profile or list of interests.

System 100 may track user contest and voting data 155 regarding a scored user's 161 participation and performance in structures events such as contests and competitions. This can include a scored user 161 initiating or joining such a contest. This can also include the promptness and completeness of a scored user's 161 content submissions or other participatory actions. This can also include how the scored user 161 fares overall and in individual rounds of a multiple-round competition. This can also include indicia of approval or disapproval (e.g. votes, thumbs up/down, numbered favorites, and “saves”) by a general population of users 160, and/or indicia of approval or disapproval by a one or more “experts,” “judges,” contest sponsors, or the like. The collective weight accorded user or public opinion can be different than the collective weight accorded “expert” opinion in an example.

System 100 may track personality profile data 156 that is generated by or collected for a scored user 161. This can include biographical, personal, or interest information submitted by a scored user 161 (e.g. age, length of time in creative field, and influences). This can also include quizzes, questionnaires, and polls taken by a scored user 161. This can also include information collected about the scored user 161, such as interests gleaned from browsing, participation (e.g. liking and commenting), or viewing history. This can also include personality profile data 156 such as described above, but regarding users other than a scored user 161.

In an example, in a use of the system 100 to determine MCS values for fashion designers, different point values or weights can be accorded to user interactions undertaken by users determined to be highly interested and knowledgeable (e.g. by analyzing their profile, and browsing and commenting history) in contemporary fashion than those determined to be less interested or knowledgeable.

In an embodiment, system 100 can assign points for various user actions, with an exemplary formula being 20% personality profile category, 50% engagement category, 30% social category. An exemplary engagement category can give points as follows [number of points in brackets]: profile creation [1], making followers or following [2], messaging followers [2], uploading assets [2], sharing content or anything to an outside social network [3], making a group [3], contributing to a group via assets [4], being invited to a project [4], making a contest [5], adding assets and comments to a contest [5], creating an accepted deliverable [6], completing a contest [8], getting in the finalists of a contest [10], and inviting a new member [15].

An exemplary social category can have a formula of social audience value times social engagement value times social reach value. An exemplary social audience value can give 2 points for each network (e.g. social, content portal) to which a scored user 161 is connected. An exemplary social engagement value can give points as follows when a scored user's 161 content is: viewed [2], liked (or similar expression of approval) [3], and shared [4]. An exemplary social reach value can give 2 points for each increment of 100 friends/followers/subscribers a scored user 161 has on a given scoring source 140. Another exemplary social reach value can give 1 point for each user connected to the scored user 161, and an additional point for each such connected user that meets one or more criteria (e.g., that user is connected to over n other users, that user posts or shares content with at least average frequency f), and then multiply the total points by a normalizing value. The above point values, formula weights, formula inputs, or network weights (e.g. pointed activities on a music publishing network versus a social network), can be set, changed, or determined by a system operator 190 in an example.

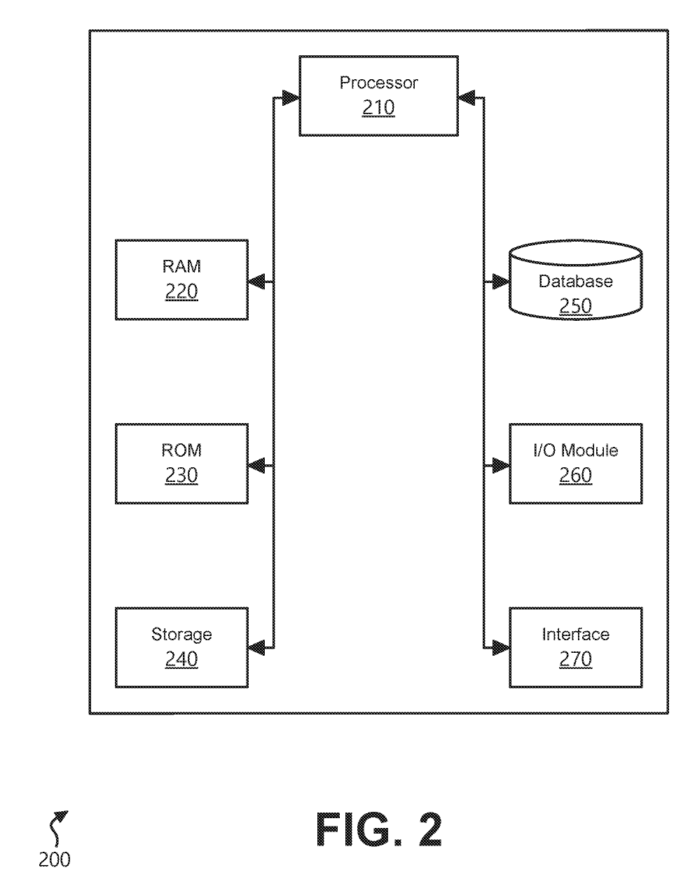

Referring now to FIG. 2, there is illustrated a processor-based computing system 200 representative of the type of computing system that can be present in or used in conjunction with a scoring server 110 or user device 170 of system 100.

For example, a processor-based computing system 200 can be used in conjunction with any one or more of transmitting signals to and from components of system 100, processing received signals, and storing, transmitting, or displaying information. The depicted computing system 200 is illustrative only and does not exclude the possibility of another processor- or controller-based system being used in or with any of the aforementioned aspects of system 100.

In one aspect, computing system 200 can include one or more hardware and/or software components configured to execute software programs, such as software for storing, processing, and analyzing data. For example, a computing system 200 may include one or more hardware components such as, for example, a processor 210, a random access memory (“RAM”) module 220, a read-only memory (“ROM”) module 230, a storage system 240, a database 250, one or more input/output (“I/O”) modules 260, and an interface module 270.

Alternatively and/or additionally, computing system 200 can include one or more software components such as, for example, a computer-readable medium including computer-executable instructions for performing methods consistent with certain disclosed embodiments. It is contemplated that one or more of the hardware components listed above may be implemented using software. For example, storage 240 can include a software partition associated with one or more other hardware components of computing system 200. Computing system 200 can include additional, fewer, and/or different components than those listed above. It is understood that the components listed above are illustrative only and not intended to be limiting or exclude suitable alternatives or additional components.

Processor 210 can include one or more processors, each configured to execute instructions (in, for example, one or more computing “threads”) and process data to perform one or more functions associated with computing system 200. The term “processor,” as generally used herein, refers to any logic processing unit, such as one or more central processing units (“CPUs”), digital signal processors (“DSPs”), application specific integrated circuits (“ASICs”), field programmable gate arrays (“FPGAs”), and similar devices.

As illustrated in FIG. 2, processor 210 may be communicatively coupled to RAM 220, ROM 230, storage 240, database 250, I/O module 260, and interface module 270. Processor 210 can be configured to execute sequences of computer program instructions to perform various processes, which will be described in detail below. The computer program instructions can be loaded into RAM 220 for execution by processor 210.

RAM 220 and ROM 230 may each include one or more devices for storing information associated with an operation of computing system 200 and/or processor 210. For example, ROM 230 may include a memory device configured to access and store information associated with computing system 200, including information for identifying, initializing, and monitoring the operation of one or more components and subsystems of computing system 200. RAM 220 may include a memory device for storing data associated with one or more operations of processor 210. For example, ROM 230 may load instructions into RAM 220 for execution by processor 210.

Storage 240 can include any type of storage device configured to store information that processor 210 needs to perform processes consistent with the disclosed embodiments.

Database 250 may include one or more software and/or hardware components that cooperate to store, organize, sort, filter, and/or arrange data used by computing system 200 and/or processor 210. For example, database 250 may include information such as uploaded content 151 or data thereabout, user interaction data 152, social graph data 153, user engagement data 154, data regarding user viewing and browsing 183 activity, contest and voting data 154, data regarding user approval 184 activity, or personality profile data 155. Alternatively, or in addition, database 250 may store more, less, or different information than described above.

I/O module 260 may include one or more components configured to communicate information with a user associated with computing system 200. For example, I/O module 260 may comprise one or more buttons, switches, touchscreens, or microphones to allow a user to input parameters associated with computing system 200. I/O module 260 can also include a display including a graphical user interface (“GUI”) and/or one or more light sources for outputting information to the user. I/O module 260 can also include one or more communication channels for connecting computing system 200 to one or more peripheral devices such as, for example, a printer, user-accessible disk drive (e.g., a USB port, floppy, CD-ROM, or DVD-ROM drive), microphone, speaker system, or any other suitable type of interface device.

Interface 270 can include one or more components configured to transmit and receive data via a communication network, such as the internet, a cellular or wireless network, a LAN, an enterprise WAN, a workstation peer-to-peer network, a direct link network, or any other suitable communication channel. For example, interface 270 may include one or more modulators, demodulators, multiplexers, demultiplexers, network communication devices, wireless devices, antennas, modems, and any other type of device configured to enable data communication via a communication network.

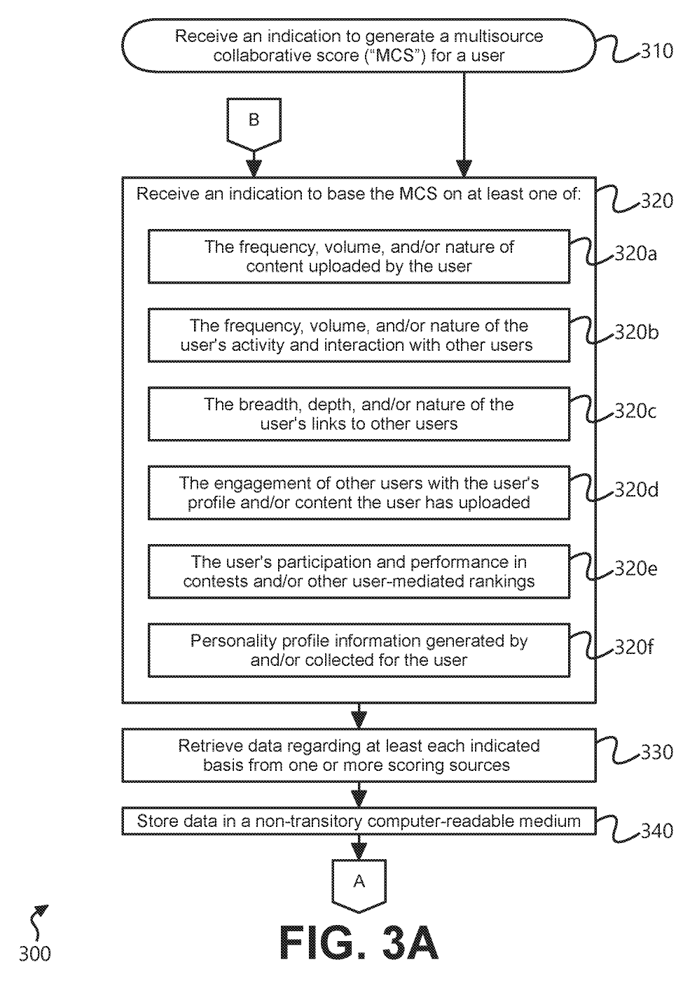

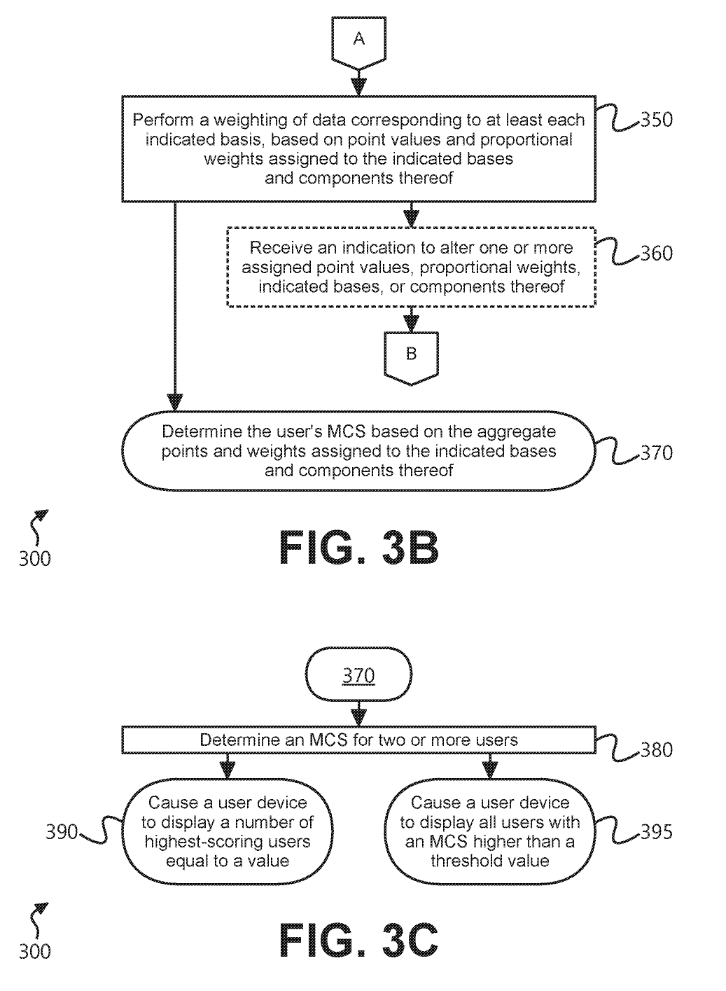

Referring now to FIG. 3A-B, there is shown an exemplary method 300 for using system 100 to determine a user MCS consistent with an embodiment. System 100 can determine MCS values by performing one or more weightings or point aggregations of scoring data 150 regarding user actions and interactions. In one aspect, system 100 can store scoring data 150 on one or more users (which can include scored 161 and non-scored 162 users) in scoring database 120.

At step 310, system 100 can receive an indication to determine a multisource collaborative score for a user. This can step can be satisfied by an indication to determine an MCS for multiple (or all) users.

At step 320, system 100 can receive an indication to base the MCS on at least one of six bases: the frequency, volume, and/or nature of content uploaded by the user 320a; the frequency, volume, and/or nature of the user's activity and interaction with other users 320b; the breadth, depth, and/or nature of the user's links to other users 320c; the engagement of other users with the user's profile and/or content the user has uploaded 320d; the user's participation and performance in contests and/or other user-mediated rankings 320e; and personality profile information generated by and/or collected for the user 320f.

The scope of data reflected by each of bases 320a-f can be at least commensurate with the corresponding above-described scoring data 150 components 151-156. For example, an indication to determine an MCS based on user engagement 320d can include some of, all of, more than, or fewer than the exemplary disclosures regarding user engagement data 154. Likewise for basis 320a and content data 151, basis 320b and community interaction data 152, basis 320c and social graph data 153, basis 320e and contest and voting data 155, and basis 320f and personality profile data 156. Step 320 can also include information other than bases 320a-f, such as a scored user's 161 sales, streams, or downloads (gleaned from, e.g., sales and merchandising platforms 145 and/or other scoring sources 140), or recommendations from established members of the scored user's 161 profession.

At step 330, system 100 can retrieve data regarding at least each indicated basis from one or more scoring sources 140. This can be accomplished by retrieving such data from scoring database 120, whether generated in situ by the scoring server 110 (as when, e.g., a scoring server 110 and one or more scoring sources 150 are combined) or received from a scoring source 150 and stored in the scoring database 120. Alternatively, or in addition, this step can be accomplished by requesting, receiving, or sampling data (e.g. in real time or in response to an indication in step 310 or 320) from one or more scoring sources 150.

At step 340, system 100 can store data retrieved from scoring sources 140 in a non-transitory computer-readable medium. This can be accomplished by, e.g. storing content, interaction, engagement, and social graph data in a storage module 240 or database 250 associated with a scoring source 140, scoring server 110, and/or scoring database 120.

At step 350, system 100 can perform a weighting of data corresponding to at least each indicated basis, based on point values and proportional weights assigned to the indicated bases (including components or constituents thereof). This step can be accomplished by retrieving the points, weights, formula inputs, and other decisional rules from scoring database 120. Alternatively, or in addition, such information can be received from a scoring source 150 or system operator 190.

A scoring server 110 or scoring database 120 can associate points (which can include positive, negative, zero, integer, and/or non-integer values) and weights (such as 0.2, 225%, etc.) with various types of information. For example, a scored user 161 gaining 100 “likes” on a piece of uploaded content on a particular scoring source 150 may be associated with a point value 3, as one component of an engagement category that itself may be associated with a weight of 0.4 in an overall MCS determination formula. System 100 can aggregate and weight points for various such components according to associated values in scoring database 120 in an example.

At step 360, system 100 may optionally receive an indication to alter one or more assigned point values, proportional weights, indicated bases, or components thereof. If an indication is made at step 360 to make an alteration, system 100 then returns to step 320 and continues from there. Otherwise, system 100 continues on to step 370.

An indication to make an alteration can come from a system operator 190 who desires to tweak system 100 in order to, e.g., broaden or narrow the number of users that meet a threshold; refine the scoring output to more accurately reflect outcome data; capture more, fewer, or different types of scoring data 150; or many other reasons. In an example, a system operator 190 can set all the various points, weights, and formula inputs that system 100 can use to determine an MCS. In another example, a system operator 190 can change the pointing for, e.g., the number of followers a scored user 161 has from 2 per 100 followers to 3 per 100 followers. In yet another example, system 100 can include hardware or software components that may automatically adjust system parameters (or give an indication to do so), based on, e.g. an algorithm or a machine learning process such as a neural net.

At step 370, system 100 can determine the user's MCS based on the aggregate points and weights assigned to the indicated bases (including components or constituents thereof). In an example, system 100 can determine an MCS according to a formula similar to the exemplary formula disclosed above in relation to FIG. 1. In another example, system 100 can determine MCS values in real-time (or nearly so) in response to evolving conditions and changes in component values occurring in one or more scoring sources 150.

Referring now to FIG. 3C, there is shown an exemplary method 300 for using system 100 to determine and display on a user device 170 one or more user MCS values, or a set (including 0, 1, or more) of users with MCS values meeting criteria, consistent with an embodiment. A user device 170 can include any suitable computing device (including scoring server 110 or a server associated with a scoring source 140) used by a scored user 161, a non-scored user 162, or system operator 190 in an example.

At step 370, system 100 can determine a user's MCS based on the aggregate points and weights assigned to the indicated bases (including components or constituents thereof). At step 380, system 100 can determine an MCS for a two or more users. This step can be accomplished by following the steps described in FIGS. 3A-B to arrive at MCS values for a plurality of users in an example.

Steps 390 and 395 may be performed in the alternative, or both may be performed. At step 390, system 100 can cause a user device 170 to display a number of highest-scoring users equal to a value. This step can be accomplished by, for example, storing or receiving a value for the number of highest-scoring users to display (e.g. number one, top five, top forty) sorting a list of highest-scoring users, and displaying in a graphical user interface on a user device 170 the top-n highest-scoring users. The display can include names, pictures, and profile information, in an example. The top users displayed can be “paged down” such that a browsing user could view, e.g., 1-10, then 11-20, in an example. In another example, the users displayed can be the lowest-scoring users. In yet another example, the users displayed can be the highest-scoring users that also meet one or more additional criteria (e.g. highest-scoring bands in the browsing user's geographic region).

At step 395, system 100 can cause a user device 170 to display all users with an MCS higher than a threshold value. This step can be accomplished by, for example, storing or receiving a value for the threshold value over which an MCS will be included (e.g. over 75), selecting all users for whom the MCS value exceeds the threshold value, and displaying in a graphical user interface on a user device 170 the selected threshold-meeting users. In an example, users above an MCS threshold can be designated as the set that will continue to be part of a competition, challenge, selection program, or top results display page. In another example, the users displayed can be those below a threshold. In yet another example, the users displayed can be the threshold-meeting users that also meet one or more criteria (e.g. threshold-meeting artists who also submitted content in response to a particular call).

It should be appreciated that in any method or step wherein system 100, server 110, or any other component, “receives” information, such receipt may be satisfied by such information being: transmitted over a communication network to, or received by, interface 270; read from storage system 240 or database 250; accessed in RAM 220 or ROM 230; or, input into I/O module 260.

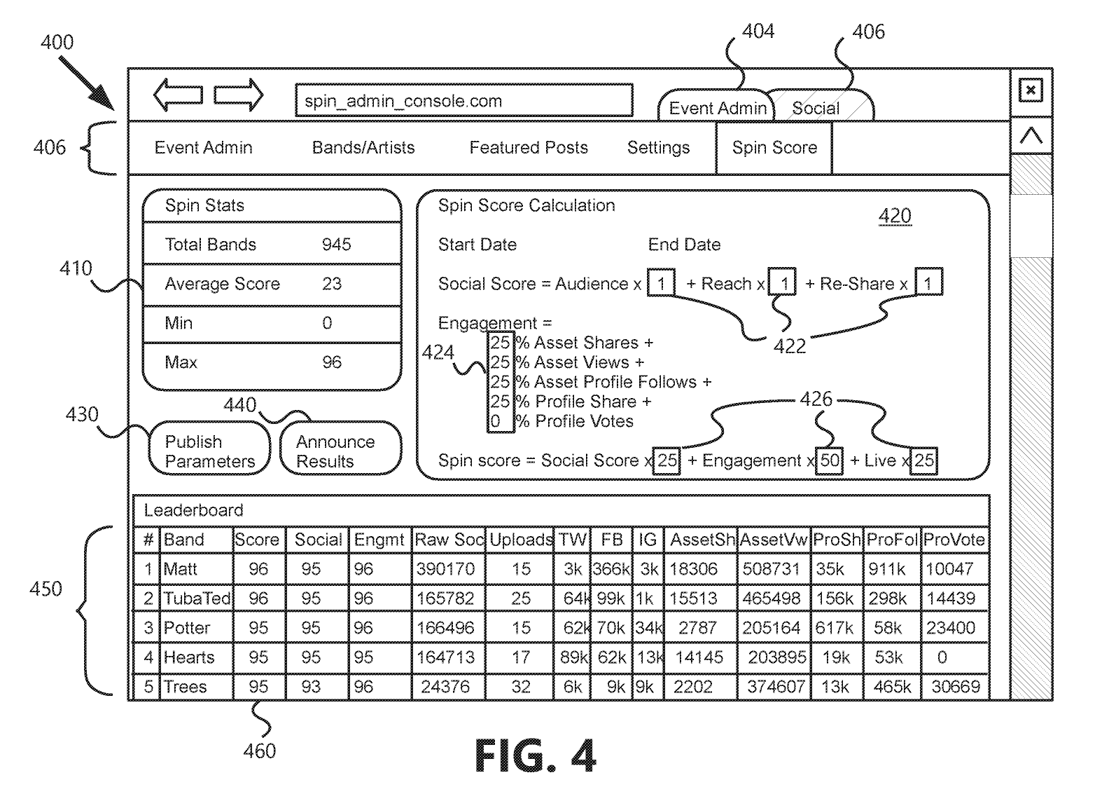

FIG. 4 includes an example illustration of an administration console 400. In one example, the console 400 can be provided from a web server and displayed in a browser executing on a computing device. The console 400 can execute separately from a social media platform. For example, the social media platform can execute in a first tab 406 of the browser, and the administrative console 400 can operate in a second tab 404.

The administrative console 400 can include a navigation bar 406 that allows an administrator to navigate through the console 400 screens. The screen shown in FIG. 4 is an example Spin Score screen. Other example screens can include event administration, performer configuration or analysis, featured social media posts, or a console settings screen.

The Spin Score screen can include a spin stats pane 410. The spin stats pane 410 can list the total number of performers (e.g., “Total Bands”) in an event. It can also list average, minimum, and maximum scores for those bands.

A spin score calculation paten 420 can allow an administrator to edit how the spins score gets calculated for the event. Different events can calculate the spin score in different ways. In particular, an administrator can set the weights 422 of the audience, reach, and reshare in calculating a social score. This can allow the administrator to adjust whether audience, reach, or reshare are more valued compared to the others.

Similarly, the administrator can adjust weights 424 for calculating engagement. Engagement attributes can include asset shares, asset views, asset profile follows, and profile votes. These attributes can be weighted to determine how much each of the attributes factors into the overall engagement score. In this example, the profile votes are weighted to not factor in at all, whereas asset shares, views, profile follows, and profile shares are counted equally.

The weights can be applied to points in one example. Different amounts of points can be awarded for actions that correspond to each attribute. As an example, an asset view occurs when a user consumes audio or video of the asset. In one example, three points can be awarded for a view. Votes occur when a fan or other user votes positively on an asset. A vote can count six points in an example. A time limit between votes, such as 24 hours for a single user, can cause the vote to be more valuable. In one example, the points awarded to the vote is inversely proportional to the number of votes cast during a time period by a voting user.

Points can also be awarded for friends or followers, such as two points each. Shared content (e.g., across a social graph) can count for 3 points in an example. Entering a challenge can count for 10 points. Fans submitting content to performer's challenge can count for two points for each fan post. Winning a challenge can count for 20 points.

Audience points can be calculated at two points for each social network associated with the performer. Engagement can include two points for each time a performer's asset is viewed and four points for each time the asset is shared. Reach points can be awarded based on number of followers, such as two points for every 100 followers.

Example social networks that can be accessed by the system include TWITTER, FACEBOOK, G+, INSTAGRAM, YOUTUBE, VIMEO, PINTREST, VINE, LINKEDIN, SOUNDCLOUD, TUMBLER, and PIC COLLAGE, among others. The content tracking provided for the social networks can differ. For example, the system can access one or more of likes, shares, comments, pins, views, ratings, and plays. Different points can be assigned to the different accessible traits of the various social networks. The system can utilize an application programming interface (“API”) to connect and source data from the social networks. The API can be programmed to make procedure calls recognized by the particular social networks that the system integrates with.

The spin score calculation pane 420 can also include controls for modifying the spin score calculation for an event. The spin score can include one or more of social score, engagement, and live performance. The controls can include weights 426 for determining how heavily to favor social score, engagement, or live performance in the calculation.

The live score can be calculated based on text matching that shows fans and other users are talking about a particular performance. The performance name can serve as a text string that is searched across the social media platforms.

In one example, the administrator can select an option, such as button 430, to publish the parameters. This can allow performers to see, for example, the leaderboard 450. In another example, it can allow performers to see spin score calculation details, such as those in pane 420. Another button 440 can allow the administrator to announce results. This can automatically email rankings to the performers, or email a link to the leaderboard 450.

Leaderboard 450 can include a detailed breakdown of attributes that contribute to the spin score 460. In the illustrated example, the columns from left to right are ranking, band (i.e., performer), social score, engagement score, raw social score, TWITTER points, FACEBOOK points, INSTAGRAM points, Assets shared, Assets viewed, Profile shares, Profile follows, and Profile votes. The shares, views, and votes, can come from multiple social platforms in one example. Alternatively, they can come all or in part from a social platform that is part of the system.

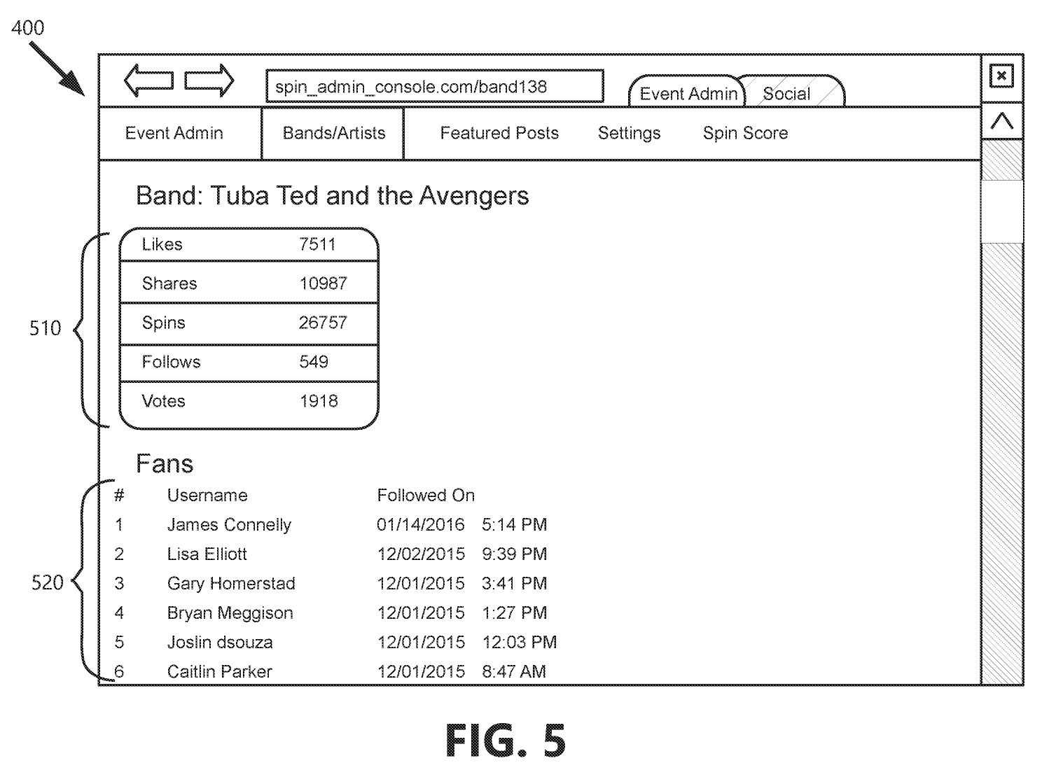

Statics for particular performers can also be analyzed. Turning to FIG. 5, a detail screen for the band “Tuba Ted and the Avengers” is shown. A scoring section 510 can show attribute score breakdown for the band. A fans section 520 can allow the administrator or the performer to view their fans that have connected across one or more social networks or within the system itself.

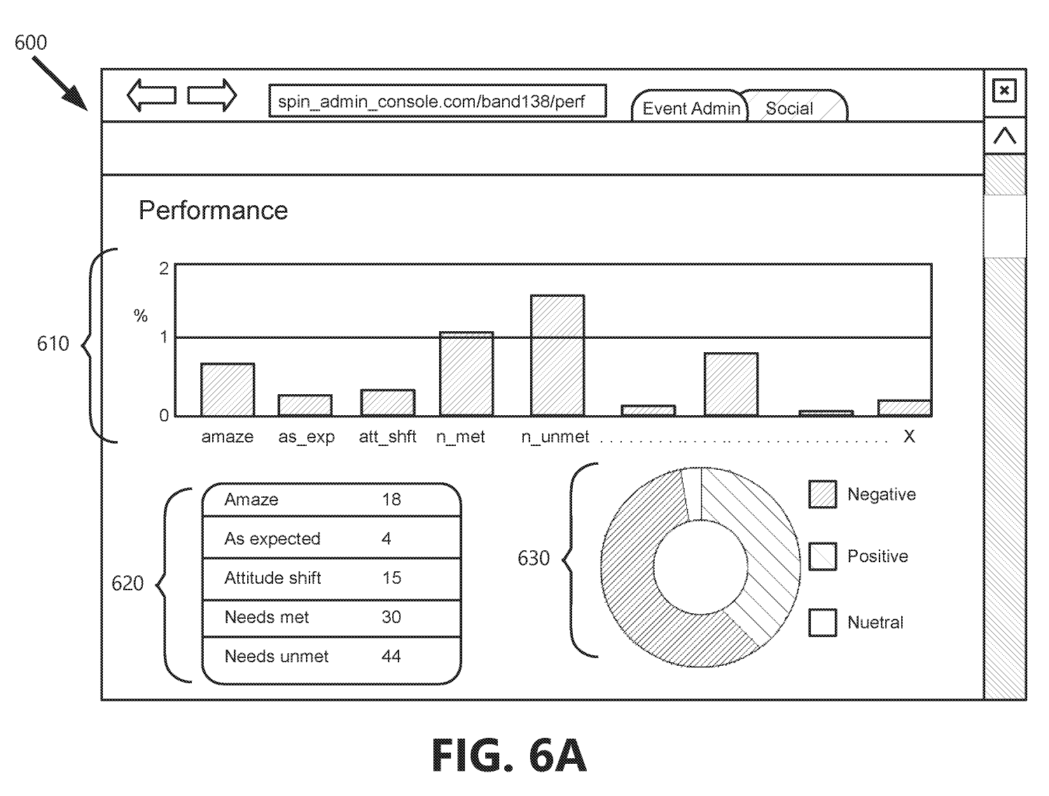

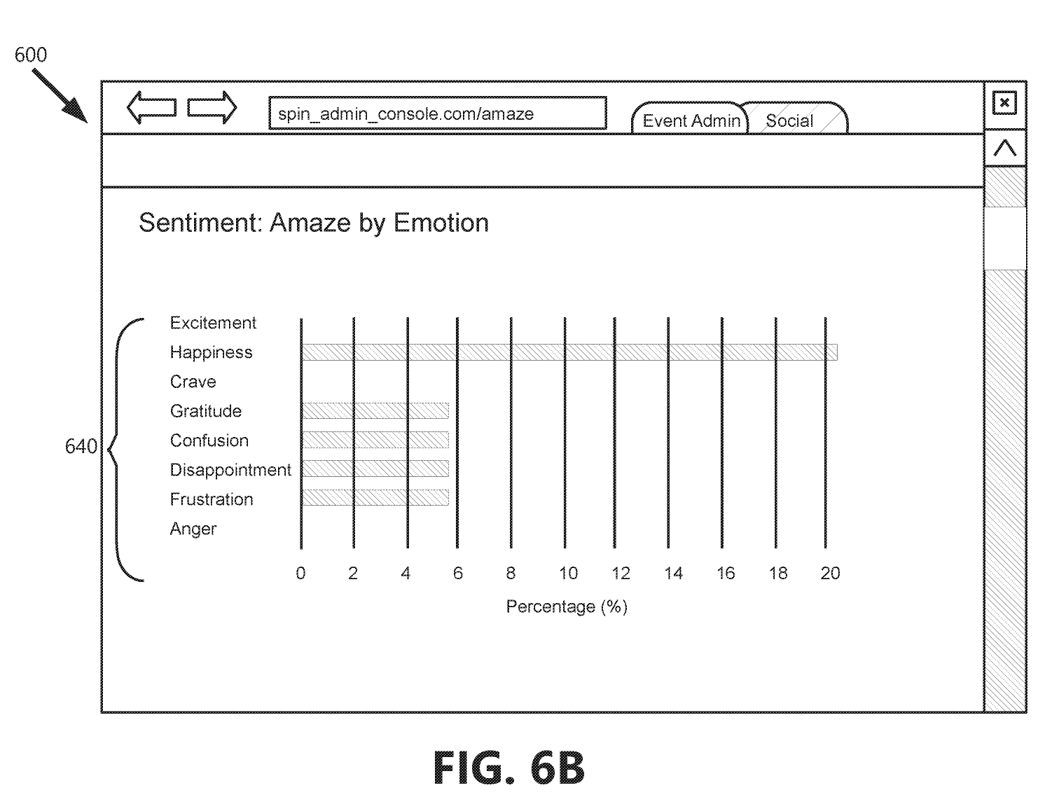

FIG. 6A is an example screen 600 for scoring a performer's live performance. The performance score can be calculated by recognizing keywords across social media feeds. The keywords that are recognized can be presented in a first bar graph 610. In one example, the word “amaze” is recognized 18 times for a particular performance, as shown in the recognition count box 620. Other recognized terms in this example include “as expected.” Additionally, based on a change in the type of words being used, an attitude shift can be recognized. Needs met or unmet can also be determined by keywords. These are only a few examples. As the bar graph 610 indicates, any number X keywords can be tracked in the system.

The keywords can be associated with different emotions, as shown in FIG. 6B. FIG. 6B shows which emotions 640 the system correlates with “amaze.” There is a strong correlation to happiness, and smaller correlations to gratitude, confusion, disappointment, and frustration. Each emotion can have a positive, neutral, or negative connotation. In this example, the emotions presented are in descending order, from very positive to very negative. Excitement can be worth multiple positive points, whereas confusion can be only slightly negative and anger can be very negative.

Therefore, a keyword such as “amaze” can add points to a positive category, a neutral category, and a negative category. Because happiness is the dominant sentiment, the word “amaze” carries mostly a positive connotation.

Returning to FIG. 6A, the number of times a keyword appears can be used to multiply the positive, neutral, and negative values associated with that keyword. With respect to “amaze,” 18 occurrences means the values of amaze can be weighted more than the values of “as expected.” “As expected” would likely carry a mostly neutral connotation, whereas “needs unmet” would carry a mostly negative connotation.

By weighting the positive, neutral, and negative values of each recognized keyword, an overall sentiment 630 can be determined. In this example, sentiment 630 is presented in a pie graph showing a slightly negative sentiment. The sentiment can be reduced to a number and used as the live performance score in an example.

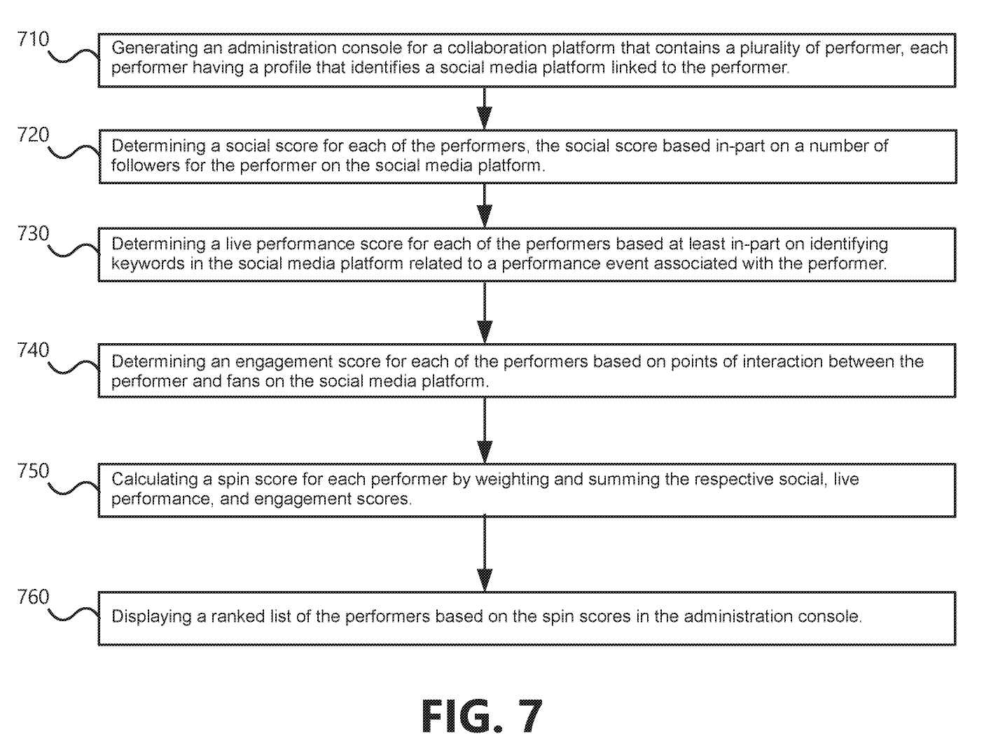

FIG. 7 includes example stages performed in a system. At stage 710, the system can generate an administration console for a collaboration platform. It can be in the form of a graphical user interface (“GUI”), such as illustrated in FIGS. 4-6B. The collaboration platform can contain a plurality of performers, each performer having a profile that identifies one or more social media platforms linked to the performer. Activity on these platforms can be used to produce various scores used in ranking the performers.

For example, at stage 720, the system can determine a social score for each of the performers. The social score can be based in-part on a number of followers for the performer on the social media platform. Other possible attributes of the social score are described above.

At stage 720, the system can determine a live performance score for each of the performers. The live performance score can be based at least in-part on identifying keywords in the social media platform related to a performance event associated with the performer. The keywords can be associated with sentiments that are positive, neutral, or negative. In this way, a keyword can have a first positive value, a second neutral value, and a third negative value. These three values can be weighted based on the number of times the keyword is recognized for the event relative to other keywords.

At stage 730, the system can determine an engagement score for each of the performers. The engagement score can be based on points of interaction between the performer and fans on the social media platform, as described above.

At stage 750, the system can calculate a spin score for each performer. The spin score can include social, performance, and engagement scores. These scores can be weighted and summed as specified in the console. The weights can be different for different events. For example, a first event can emphasize a live performance score more than a second event, such as a songwriting event.

At stage 760, the system can display a ranked list of the performers based on the spin scores in the administration console. This score can be used to determine event winners and can be published to the participating performers or fans.

As used herein, an artist is one example of a performer. For example, a cook can be a performer. An actor can also be a performer. A baseball player can be a performer. Although examples are explained with respect to artists, the examples can operate with any other type of performer.

Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the invention being indicated by the following claims.

What is claimed is:

1. A non-transitory, computer-readable medium containing instructions executed by at least one processor to perform stages for identifying successful performers, the stages comprising:
generating an administration console for a collaboration platform that contains a plurality of performers, each performer having a profile that identifies a social media platform linked to the performer;
determining a social score for each of the performers, the social score based in-part on a number of followers for the performer on the social media platform;
determining a live performance score for each of the performers based at least in-part on identifying keywords in the social media platform related to a performance event associated with the performer;
determining an engagement score for each of the performers based on points of interaction between the performer and fans on the social media platform;
calculating a spin score for each performer by weighting and summing the respective social, live performance, and engagement scores; and
displaying a ranked list of the performers based on the spin scores in the administration console.

2. The non-transitory, computer-readable medium of claim 1, wherein the social, live performance, and engagement scores are weighted differently with respect to one another for different performer competitions.

3. The non-transitory, computer-readable medium of claim 1, wherein calculating the engagement score for a first performer includes determining a number of asset shares, asset views, asset profile follows, profile shares, and profile views for the first performer.

4. The non-transitory, computer-readable medium of claim 3, wherein the administration console includes options for changing weights of the number of asset shares, asset views, asset profile follows, profile shares, and profile views with respect to one another for calculating the engagement score.

5. The non-transitory, computer-readable medium of claim 1, wherein the administration console further provides a curator score for an entity associated with multiple performers of the plurality of performers, the curator score being based on the spin scores of the multiple performers.

6. The non-transitory, computer-readable medium of claim 1, wherein determining the engagement score includes assigning point values to at the respective performer creating a profile, defining a group, and contributing an asset that is collaboratively shared with the group.

7. The non-transitory, computer-readable medium of claim 1, wherein the engagement score of a first user is calculated based on point values assigned to the first user sharing content with fans.

8. The non-transitory, computer-readable medium of claim 1, wherein the engagement score of a first user is calculated based on point values assigned to at least the first user inviting others to projects and the first user making a contest that is accessible through the collaboration platform.

9. The non-transitory, computer-readable medium of claim 1, wherein the collaboration platform facilitates a competition that includes an audition, and wherein engagement scores are calculated during the audition.

10. The non-transitory, computer-readable medium of claim 1, the stages further including generating a personality profile for the first user, and weighting the spin score based on the personality profile.

11. A method for predicting successful performers, comprising:
generating an administration console for a collaboration platform that contains a plurality of performers, each performer having a profile that identifies a social media platform linked to the performer;
determining a social score for each of the performers, the social score based in-part on a number of followers for the performer on the social media platform;
determining a live performance score for each of the performers based at least in-part on identifying keywords in the social media platform related to a performance event associated with the performer;
determining an engagement score for each of the performers based on points of interaction between the performer and fans on the social media platform;
calculating a spin score for each performer by weighting and summing the respective social, live performance, and engagement scores; and
displaying a ranked list of the performers based on the spin scores in the administration console.

12. The method of claim 11, wherein the social, live performance, and engagement scores are weighted differently with respect to one another for different performer competitions.

13. The method of claim 11, wherein calculating the engagement score for a first performer includes determining a number of asset shares, asset views, asset profile follows, profile shares, and profile views for the first performer.

14. The method of claim 13, wherein the administration console includes options for changing weights of the number of asset shares, asset views, asset profile follows, profile shares, and profile views with respect to one another for calculating the engagement score.

15. The method of claim 11, wherein the administration console further provides a curator score for an entity associated with multiple performers of the plurality of performers, the curator score being based on the spin scores of the multiple performers.

16. A system for predicting successful performers, comprising:
a non-transitory computer-readable medium containing instructions; and
a processor that executes the instructions to perform stages comprising:
generating an administration console for a collaboration platform that contains a plurality of performers, each performer having a profile that identifies a social media platform linked to the performer;
determining a social score for each of the performers, the social score based in-part on a number of followers for the performer on the social media platform;
determining a live performance score for each of the performers based at least in-part on identifying keywords in the social media platform related to a performance event associated with the performer;
determining an engagement score for each of the performers based on points of interaction between the performer and fans on the social media platform;
calculating a spin score for each performer by weighting and summing the respective social, live performance, and engagement scores; and
displaying a ranked list of the performers based on the spin scores in the administration console.

17. The system of claim 16, wherein the social, live performance, and engagement scores are weighted differently with respect to one another for different performer competitions.

18. The system of claim 16, wherein calculating the engagement score for a first performer includes determining a number of asset shares, asset views, asset profile follows, profile shares, and profile views for the first performer.

19. The system of claim 18, wherein the administration console includes options for changing weights of the number of asset shares, asset views, asset profile follows, profile shares, and profile views with respect to one another for calculating the engagement score.

20. The system of claim 16, wherein the administration console further provides a curator score for an entity associated with multiple performers of the plurality of performers, the curator score being based on the spin scores of the multiple performers.
